(19) United States
(12) Patent Application Publication
(10) Pub. No.: US 2021/0216754 A1
(43) Pub. Date: Jul. 15, 2021

(54) MONITORING DEVICE, SYSTEM, METHOD, AND RECORDING MEDIUM

(71) Applicant: NEC Platforms, Ltd., Kawasaki-shi, Kanagawa (JP)

(72) Inventor: Hirofumi KUMADA, Kanagawa (JP)

(73) Assignee: NEC Platforms, Ltd., Kawasaki-shi, Kanagawa (JP)

(21) Appl. No.: 16/760,524

(22) PCT Filed: Nov. 1, 2018
(86) PCT No.: PCT/JP2018/040642

§ 371 Date: Apr. 30, 2020

(30) Foreign Application Priority Data
Nov. 2, 2017 (JP) 2017-212863

(51) Int. Cl. G06K 9/00; G06K 9/62

(52) U.S. Cl. CPC G06K 9/00288; G06K 9/00771; G06K 9/6201

(57) ABSTRACT

In order to enable an improvement in the possibility of shortening the time required to search for a visitor without the visitor holding a specific piece of equipment, this monitoring device accepts input of a key image, which is a facial image of a person serving as a key, finds whether the facial image of the same person as in the key image has been stored in a correspondence information storage unit which stores the facial images of a plurality of persons and correspondence relationships of the facial images, and outputs the result.

### TECHNICAL FIELD

The present invention relates to a monitoring device, a system, a method, and a recording medium for monitoring visitors to a facility.

### BACKGROUND ART

In the case of searching for a search target such as a lost child or a guardian of the child in a commercial facility, a theme park, or the like, in general, the search target is often called out by broadcast. However, according to this method, it is likely that it takes time to find/meet the search target.

There is also a method of lending electronic tags or global positioning system (GPS) devices to visitors and searching for the electronic tag or the GPS device which is held by a search target, however, such an electronic tag or a GPS device are disturbances for the visitor because of an increase of baggage. Further, there are also risks of loss, breakage, and the like of such lent devices.

For this problem, in the method described in PTL 1, first, by an operation of the visitor, a registration device registers face images of group members in a portable terminal of each of the group members. In the case of searching, a searcher (searching person) causes a monitoring terminal to read the face images registered in such a portable terminal, and selects a face image of a search target (person to be searched). Then, a server device collates images captured by monitoring cameras in the facility with the face image of the search target, thereby confirming a location of the search target, and the monitoring terminal displays a search result. Thus, it becomes possible for the searcher to confirm a latest location of the search target by the monitoring terminal, and therefore, there can be an increased possibility that time required for finding/meeting the search target can be shortened.

### CITATION LIST

### Patent Literature

[PTL 1] Japanese Unexamined Patent Application Publication No. 2004-177997
[PTL 2] Japanese Unexamined Patent Application Publication No. 2013-196423

### SUMMARY OF INVENTION

### Technical Problem

However, in the method described in PTL 1, each of the visitors needs to hold a portable terminal in order to register the face images of the group members in the portable terminal. Therefore, when a visitor does not own a portable terminal, it is necessary to lend a portable terminal to the visitor, and accordingly, an increase of baggage occurs for the visitor. Further, there are also risks of loss, breakage and the like of the lent terminal.

An object of the present invention is to provide a monitoring device, a system, a method, and a recording medium, which enable increasing a possibility that time required for searching for a visitor can be shortened even when the visitor does not hold a specific instrument.

### Solution to Problem

In order to solve the above-mentioned problem, a monitoring device according to the present invention includes: a face image input means for receiving an input of a key image being a face image of a person taken as a key; and an image search means for searching whether the face image of a same person as the key image is stored in a correspondence information storage unit that stores the face images of a plurality of persons and correspondence relationships among the face images, and outputting a result of the search.

A monitoring method according to the present invention includes: receiving an input of a key image being a face image of a person taken as a key; and searching whether the face image of a same person as the key image is stored in a correspondence information storage unit that stores the face images of a plurality of persons and correspondence relationships among the face images, and outputting a result of the search.

A monitoring program stored in a computer-readable recording medium according to the present invention causes a computer to execute: a face image input function of receiving an input of a key image being a face image of a person taken as a key; and an image search function of searching whether the face image of a same person as the key image is stored in a correspondence information storage unit that stores the face images of a plurality of persons and correspondence relationships among the face images, and outputting a result of the search.

### Advantageous Effects of Invention

The monitoring device, the system, the method and the recording medium according to the present invention enable increasing a possibility that time required for searching for a visitor can be shortened even when the visitor does not hold a specific instrument.

### BRIEF DESCRIPTION OF DRAWINGS

FIG. 1 shows a diagram illustrating a configuration example of a monitoring device of a first example embodiment of the present invention.

FIG. 2 shows a diagram illustrating an operation example of the monitoring device of the first example embodiment of the present invention.

FIG. 3 shows a diagram illustrating a configuration example of a monitoring device of a second example embodiment of the present invention.

FIG. 4 shows a diagram illustrating an operation example of the monitoring device of the second example embodiment of the present invention.

FIG. 5 shows a diagram illustrating a configuration example of a monitoring system of a third example embodiment of the present invention.

FIG. 6 shows a diagram illustrating a configuration example of a monitoring device and a correspondence information storage device of the third example embodiment of the present invention.

FIG. 7 shows a diagram illustrating a configuration example of a monitoring device of a fourth example embodiment of the present invention.

FIG. 8 shows a diagram illustrating an operation example of the monitoring device of the fourth example embodiment of the present invention.

FIG. 9 shows a diagram illustrating an operation example of a monitoring device of a fifth example embodiment of the present invention.

FIG. 10 shows a diagram illustrating a configuration example of a monitoring device of a sixth example embodiment of the present invention.

FIG. 11 shows a diagram illustrating a hardware configuration example of each of the example embodiments of the present invention.

### EXAMPLE EMBODIMENT

### First Example Embodiment

A first example embodiment of the present invention is described.

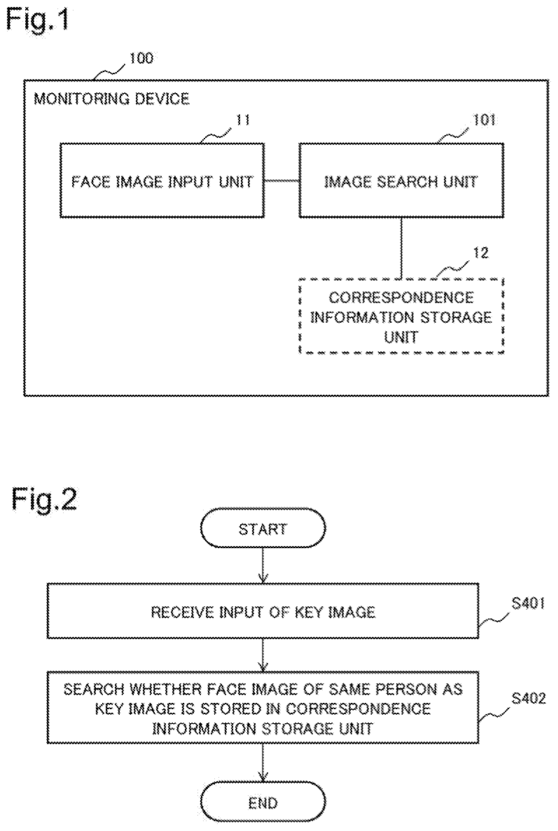

A configuration example of a monitoring device 100 of the present example embodiment is illustrated in FIG. 1.

The monitoring device 100 of the present example embodiment is composed of a face image input unit 11, an image search unit 101, and a correspondence information storage unit 12.

The face image input unit 11 is a portion that receives an input of a key image that is a face image of a person taken as a key. The image search unit 101 is a portion that searches whether a face image of the same person as the key image is stored in the correspondence information storage unit 12 that stores face images of a plurality of persons and correspondence relationships among the face images, and outputs a result of the search.

The monitoring device 100 is configured as described above, whereby the monitoring device 100 searches whether the face image of the same person as the key image is stored in the correspondence information storage unit 12 that stores the face images of the plurality of persons and the correspondence relationships among the face images, and outputs a result of the search. Thus, a user of the monitoring device 100 becomes able to know whether there is a person associated with the person taken as a key. For example, when a staff of a facility finds a child alone, even if the child does not hold a specific instrument, it becomes possible to know whether there is a person who came with the child, and to take countermeasures such as talking and protection. Therefore, it becomes possible to increase a possibility that a time required to search for a visitor can be shortened even if the visitor does not hold a specific instrument.

Next, an example of an operation of the monitoring device 100 of the present example embodiment is illustrated in FIG. 2.

The face image input unit 11 receives an input of a key image that is the face image of the person taken as a key (step S401). Next, the image search unit 101 searches whether a face image of the same person as the key image is stored in the correspondence information storage unit 12 that stores the face images of the plurality of persons and the correspondence relationships among the face images, and outputs a result of the search (step S402).

By operating as described above, the monitoring device 100 searches whether the face image of the same person as the key image is stored in the correspondence information storage unit 12 that stores the face images of the plurality of persons and the correspondence relationships among the face images, and outputs a result of the search. Thus, the user of the monitoring device 100 becomes able to know whether there is a person associated with the person taken as a key. Therefore, it becomes possible to increase the possibility that the time required to search for a visitor can be shortened even if the visitor does not hold a specific instrument.

As described above, in the first example embodiment of the present invention, the monitoring device 100 searches whether the face image of the same person as the key image is stored in the correspondence information storage unit 12 that stores the face images of the plurality of persons and the correspondence relationships among the face images, and outputs a result of the search. Thus, the user of the monitoring device 100 becomes able to know whether there is a person associated with the person taken as a key. Therefore, it becomes possible to increase the possibility that the time required to search for a visitor can be shortened even if the visitor does not hold a specific instrument.

### Second Example Embodiment

Next, a second example embodiment of the present invention is described.

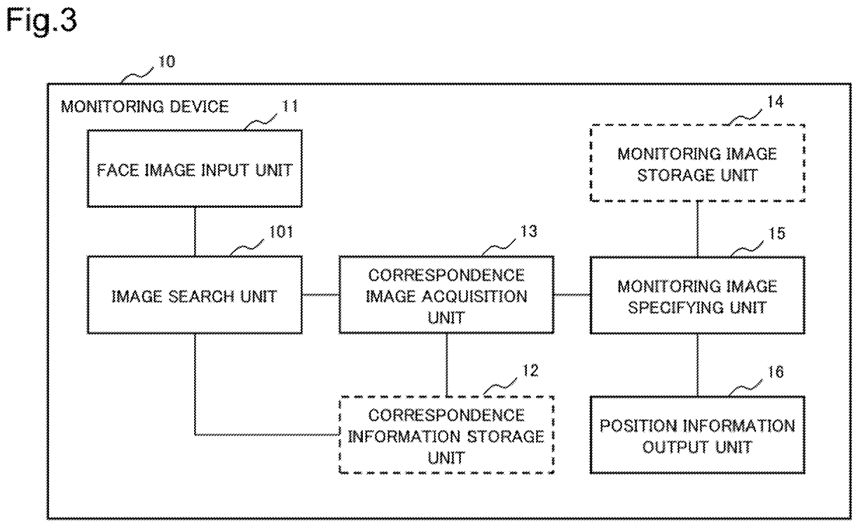

A configuration example of a monitoring device 10 of the present example embodiment is illustrated in FIG. 3.

The monitoring device 10 of the present example embodiment is composed of a face image input unit 11, an image search unit 101, a correspondence information storage unit 12, a correspondence image acquisition unit 13, a monitoring image storage unit 14, a monitoring image specifying unit 15, and a position information output unit 16.

The face image input unit 11 is a portion that receives an input of a key image that is a face image of a person taken as a key. The image search unit 101 is a portion that searches whether a face image of the same person as the key image is stored in the correspondence information storage unit 12 that stores face images of a plurality of persons and correspondence relationships among the face images. The correspondence image acquisition unit 13 is a portion that, when the face image of the same person as the key image is stored in the correspondence information storage unit 12, acquires a face image, which is related to the face image of the same person as the key image, as a correspondence image from the correspondence information storage unit 12. The monitoring image specifying unit 15 is a portion that specifies a monitoring image, in which a person of the correspondence image is imaged, from among monitoring images of the monitoring image storage unit 14 that stores the monitoring images imaged by the monitoring cameras. The position information output unit 16 is a portion that outputs position information of the monitoring camera that has imaged the specified monitoring image.

The monitoring device 10 is configured as described above, whereby the monitoring device 10 receives the input of the key image, and acquires the face image, which corresponds to the face image of the same person as the key image, as the correspondence image from the correspondence information storage unit 12. Then, the monitoring device 10 specifies the monitoring image, in which the person of the correspondence image is imaged, from among the monitoring images, and outputs the position information of the monitoring camera that has imaged the specified monitoring image. Thus, a user of the monitoring device 10 inputs a face image of the person, who corresponds to the search target, to the monitoring device 10, thus making it possible to know a position at which the search target related to the person is imaged by the monitoring camera. That is, when the staff of the facility finds a lost child, even if a guardian of the child does not hold a specific instrument, it becomes possible to know a position of the guardian by inputting a face image of the lost child to the monitoring device 10. Therefore, it becomes possible to increase the possibility that the time required to search for a visitor can be shortened even if the visitor does not hold a specific instrument.

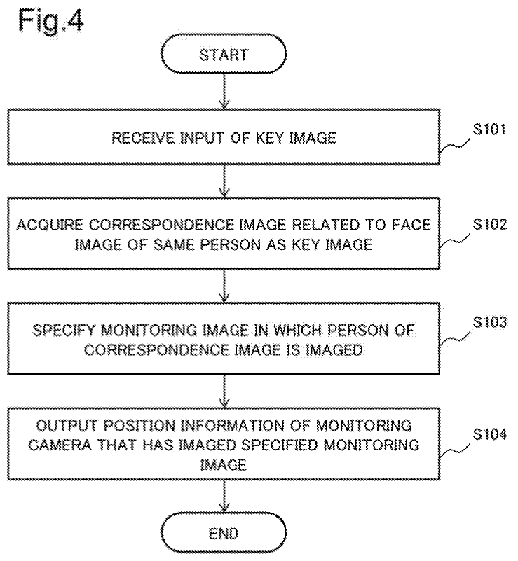

Next, an example of an operation of the monitoring device 10 of the present example embodiment is illustrated in FIG. 4.

The face image input unit 11 receives an input of a key image (step S101). The image search unit 101 searches whether the face image of the same person as the key image is stored in the correspondence information storage unit 12. When the face image of the same person as the key image is stored in the correspondence information storage unit 12, the correspondence image acquisition unit 13 acquires the face image, which corresponds to the face image of the same person as the key image, as the correspondence image from the correspondence information storage unit 12 (step S102). The monitoring image specifying unit 15 specifies the monitoring image, in which the person of the correspondence image is imaged, from among monitoring images of the monitoring image storage unit 14 (step S103). The position information output unit 16 outputs the position information of the monitoring camera that has imaged the specified monitoring image (step S104).

By operating as described above, the monitoring device 10 receives the input of the key image, and acquires the face image, which corresponds to the face image of the same person as the key image, as the correspondence image from the correspondence information storage unit 12. Then, the monitoring device 10 specifies the monitoring image, in which the person of the correspondence image is imaged, from among the monitoring images, and outputs the position information of the monitoring camera that has imaged the specified monitoring image. Thus, the user of the monitoring device 10 inputs the face image of the person, who corresponds to the search target, to the monitoring device 10, thus making it possible to know the position at which the search target related to the person is imaged by the monitoring camera. Therefore, it becomes possible to increase the possibility that the time required to search for a visitor can be shortened even if the visitor does not hold a specific instrument.

As described above, in the second example embodiment of the present invention, the monitoring device 10 receives the input of the key image, and acquires the face image, which corresponds to the face image of the same person as the key image, as the correspondence image from the correspondence information storage unit 12. Then, the monitoring device specifies the monitoring image, in which the person of the correspondence image is imaged, from among the monitoring images, and outputs the position information of the monitoring camera that has imaged the specified monitoring image. Thus, the user of the monitoring device 10 inputs the face image of the person, who corresponds to the search target, to the monitoring device 10, thus making it possible to know the position at which the search target related to the person is imaged by the monitoring camera. Therefore, it becomes possible to increase the possibility that the time required to search for a visitor can be shortened even if the visitor does not hold a specific instrument.

### Third Example Embodiment

Next, a third example embodiment of the present invention is described. In the present example embodiment, the monitoring device 20 is described by using a more specific example.

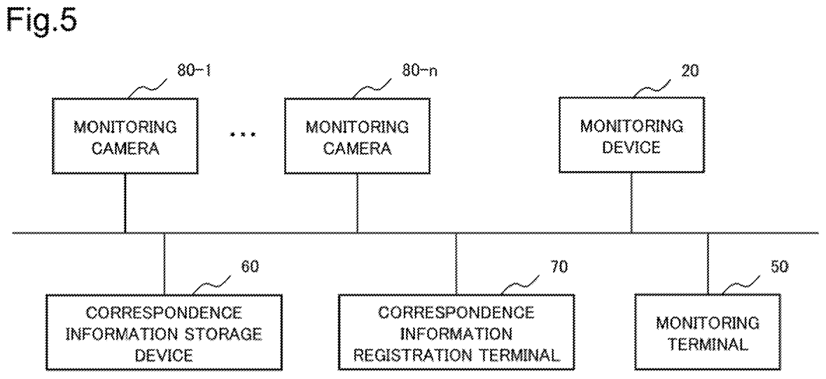

First, a configuration example of a monitoring system of the present example embodiment is illustrated in FIG. 5. A transmission/reception system of the present example embodiment is composed of a monitoring device 20, a monitoring terminal 50, a correspondence information storage device 60, a correspondence information registration terminal 70, monitoring cameras 80 (80-1 to 80-n (n is an integer of 1 or more)). The monitoring device 20 may be provided with a function of the correspondence information storage device 60. The monitoring terminal 50 may be provided with a function of the correspondence information registration terminal 70.

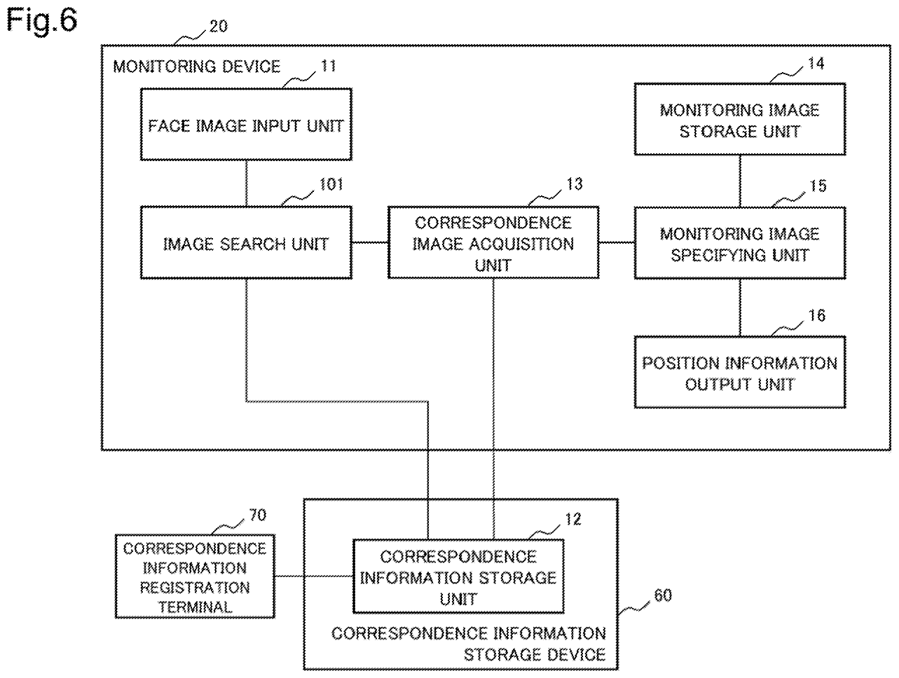

Next, a configuration example of the monitoring device 20 and the correspondence information storage device 60 of the present example embodiment is illustrated in FIG. 6.

The correspondence information storage device 60 of the present example embodiment includes the correspondence information storage unit 12 of the monitoring device 10 of the second example embodiment. The correspondence information storage unit 12 is a portion that stores face images of a plurality of persons and correspondence relationships between the face images. The user registers the face images and the correspondence relationships among the face images in the correspondence information storage unit 12 by using the correspondence information registration terminal 70.

For example, when a guardian and a child enter the facility, the staff of the facility images a photograph in which the two are imaged together by using the correspondence information registration terminal 70. Then, the correspondence information registration terminal 70 causes the correspondence information storage device 60 to store the imaged photograph. Thus, face images of the guardian and the child are associated with each other and are stored in the correspondence information storage unit 12.

The correspondence information registration terminal 70 is a camera provided with a communication function, a communication terminal provided with a camera function, or the like. Alternatively, the correspondence information registration terminal 70 may be provided at an entrance gate, and may automatically image visitors. Further, the correspondence information registration terminal 70 may image the face images one person by one person, and may cause the correspondence information storage device 60 to store the imaged face images in association with each person. Further, it is possible to associate one or more face images with one face image.

The monitoring device 20 of the present example embodiment has a configuration in which the correspondence information storage unit 12 is excluded from the monitoring device 10 of the second example embodiment.

A face image input unit 11 is a portion that receives the input of the key image that is the face image of the person taken as a key. The user inputs the key image to the face image input unit 11 of the correspondence information storage device 60 by using the monitoring terminal 50.

For example, when the staff of the facility finds a lost child, the staff images the lost child by using the monitoring terminal 50. Then, the monitoring terminal 50 inputs a face image of the lost child to the face image input unit 11. In this case, the face image of the child is the key image. Alternatively, when, for example, a guardian who has noticed an absence of the child talks to the staff, the staff images the guardian by using the monitoring terminal 50. In this case, a face image of the guardian is the key image.

An image search unit 101 is a portion that searches whether the face image of the same person as the key image is stored in the correspondence information storage unit 12. The correspondence image acquisition unit 13 is a portion that, when the face image of the same person as the key image is stored in the correspondence information storage unit 12, acquires a face image, which corresponds to the face image of the same person as the key image, as a correspondence image from the correspondence information storage unit 12. Here, the correspondence image acquired by a correspondence image acquisition unit 13 is a face image of the search target.

For example, when the face image of the child is the key image, the image search unit 101 searches for a face image, which is determined to be the same person as the key image (face image of the child), from among the face images registered in the correspondence information storage unit 12. Then, the correspondence image acquisition unit 13 acquires a face image (face image of the guardian), which corresponds to the face image of the same person as the key image, from the correspondence information storage unit 12. Likewise, when the face image of the guardian is the key image, the correspondence image acquisition unit 13 acquires a face image of the child related to the guardian.

A monitoring image storage unit 14 is a portion that stores monitoring images imaged by the monitoring cameras 80 (80-1 to 80-n). In the present example embodiment, it is assumed that the monitoring image storage unit 14 stores the monitoring images, which were imaged for a predetermined time in the past, together with imaging time information and position information of the monitoring cameras 80 which have imaged the monitoring images.

A monitoring image specifying unit 15 is a portion that specifies the monitoring image, in which the person of the correspondence image is imaged, from among the monitoring images of the monitoring image storage unit 14. That is, the monitoring image specifying unit 15 specifies the monitoring image in which the search target is imaged. When there are a plurality of face images related to the face image of the same person as the person of the key image, and the correspondence image acquisition unit 13 acquires a plurality of the correspondence images, the monitoring image specifying unit 15 may specify the monitoring images for all of the correspondence images, or may specify the monitoring image for a predetermined correspondence image. Further, the monitoring image specifying unit 15 may specify all of the monitoring images in which the person of the correspondence image is imaged, or may specify only a monitoring image that satisfies a predetermined condition, such as a latest monitoring image.

A position information output unit 16 is a portion that outputs the position information of the monitoring camera 80 that has imaged the monitoring image specified by the monitoring image specifying unit 15. In the present example embodiment, it is assumed that the position information output unit 16 outputs the position information to the monitoring terminal 50, and that the monitoring terminal 50 displays the position information. In such a way, the monitoring terminal 50 displays the position at which the search target is imaged by the monitoring camera 80.

The position information output unit 16 may output information such as the correspondence image, the specified monitoring image, and an imaging time of the monitoring image together with the position information, and the monitoring terminal 50 may display these pieces of information.

The monitoring device 20 is configured as described above, whereby the monitoring device 20 receives the input of the key image, and acquires the face image, which is related to the face image of the same person as the key image, as the correspondence image, from the correspondence information storage unit 12. Then, the monitoring device 20 specifies the monitoring image, in which the person of the correspondence image is imaged, from among the monitoring images, and outputs the position information of the monitoring camera that has imaged the specified monitoring image. Thus, the user of the monitoring device 20 inputs the face image of the person, who is related to the search target, to the monitoring device 20, thus making it possible to know the position at which the search target related to the person is imaged by the monitoring camera. That is, when the staff of the facility finds a lost child, even if a guardian of the child does not hold a specific instrument, it becomes possible to know a position of the guardian by inputting a face image of the lost child to the monitoring device 20. Therefore, it becomes possible to increase the possibility that the time required to search for a visitor can be shortened even if the visitor does not hold a specific instrument.

Next, an operation example of the monitoring system of the present example embodiment is described with reference to FIG. 4. Here, an operation when a staff finds a lost child is described.

First, when the visitors enter the facility, the staff images a photograph of the visitors, for example, a photograph in which the guardian appears together with the child by using the correspondence information registration terminal 70. Then, the correspondence information registration terminal 70 registers the photograph in the correspondence information storage device 60. Thus, the face image of the guardian, the face image of the child, and the fact that these correspond to each other are registered in the correspondence information storage unit 12.

Next, at the time of finding the lost child, the staff images a photograph of the lost child by using the monitoring terminal 50. Then, the monitoring terminal 50 inputs the photograph (key image) of the lost child to the monitoring device 20, whereby the monitoring device 20 receives the input of the key image (step S101).

Next, the monitoring device 20 searches the correspondence information storage unit 12 for the face image of the same person (lost child) as the key image, and acquires the face image (face image of the guardian), that is related to the face image of the same person as the key image, as the correspondence image (step S102).

Next, the monitoring image specifying unit 15 specifies the monitoring image, in which the person (guardian) of the correspondence image is imaged, from among the monitoring images of the monitoring image storage unit 14 (step S103).

Then, the position information output unit 16 outputs the position information of the monitoring camera 80 that has imaged the monitoring image specified by the monitoring image specifying unit 15 (step S104).

By operating as described above, the monitoring device 20 receives the input of the key image, and acquires the face image, which is related to the face image of the same person as the key image, as the correspondence image from the correspondence information storage unit 12. Then, the monitoring device 20 specifies the monitoring image, in which the person of the correspondence image is imaged, from among the monitoring images, and outputs the position information of the monitoring camera that has imaged the specified monitoring image. Thus, the user of the monitoring device 20 inputs the face image of the person, who is related to the search target, to the monitoring device 20, thus making it possible to know the position at which the search target related to the person is imaged by the monitoring camera. Therefore, it becomes possible to increase the possibility that the time required to search for a visitor can be shortened even if the visitor does not hold a specific instrument.

As described above, in the third example embodiment of the present invention, the monitoring device 20 receives the input of the key image, and acquires the face image, which is related to the face image of the same person as the key image, as the correspondence image from the correspondence information storage unit 12. Then, the monitoring device 20 specifies the monitoring image, in which the person of the correspondence image is imaged, from among the monitoring images, and outputs the position information of the monitoring camera that has imaged the specified monitoring image. Thus, the user of the monitoring device 20 inputs the face image of the person, who is related to the search target, to the monitoring device 20, thus making it possible to know the position at which the search target related to the person is imaged by the monitoring camera. Therefore, it becomes possible to increase the possibility that the time required to search for a visitor can be shortened even if the visitor does not hold a specific instrument.

### Fourth Example Embodiment

Next, a fourth example embodiment of the present invention is described.

The monitoring device 20 of the third example embodiment can search for the search target when the search target is present in the facility. However, the monitoring device 20 cannot search for the search target when the search target is present out of the facility.

Therefore, a monitoring device 30 of the present example embodiment notifies the monitoring terminal 50, which is held by the facility staff, that a person whose face image is stored in the correspondence information storage unit 12 is going to leave the facility alone when such a case occurs.

The person whose face image is stored in the correspondence information storage unit 12 is a person who has visited the facility together with someone. Therefore, it is highly possible that the person whose face image is stored in the correspondence information storage unit 12 may not leave the facility normally when the person is going to leave the facility alone. In such a case, the monitoring device 30 of the present example embodiment issues a notice to the monitoring terminal 50.

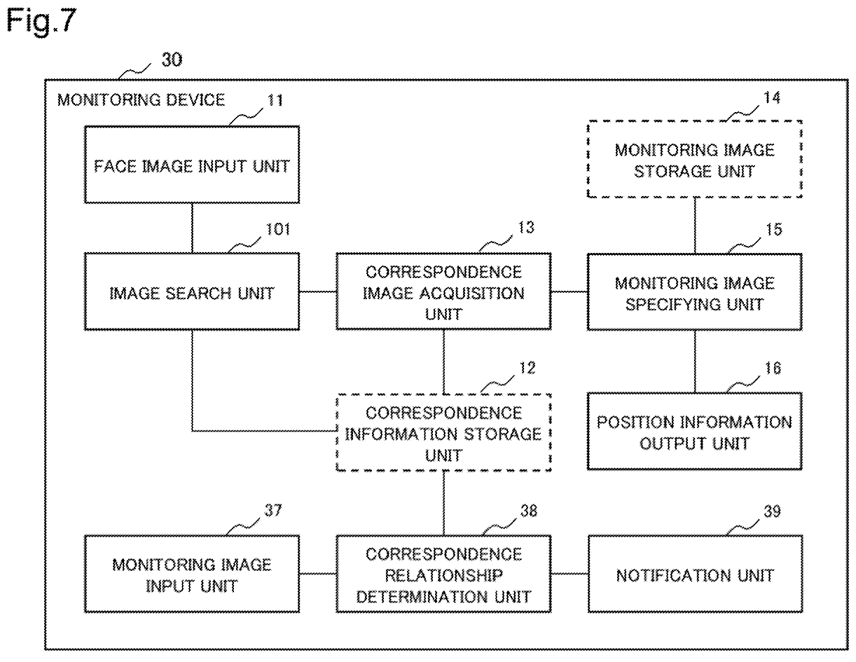

First, a configuration example of the monitoring device 30 of the present example embodiment is illustrated in FIG. 7.

The monitoring device 30 (FIG. 7) has a configuration in which a monitoring image input unit 37, a correspondence relationship determination unit 38 and a notification unit 39 are added to the monitoring device 10 (FIG. 3) of the second example embodiment. A correspondence information storage unit 12 and a monitoring image storage unit 14 may be present on a device other than the monitoring device 30.

A face image input unit 11, an image search unit 101, a correspondence information storage unit 12, a correspondence image acquisition unit 13, a monitoring image storage unit 14, a monitoring image specifying unit 15, and a position information output unit 16 are similar to those of the third example embodiment, and accordingly, a description thereof is omitted.

The monitoring image input unit 37 is a portion that sequentially receives monitoring images (second monitoring images) from a predetermined monitoring camera 80 (second monitoring camera). In the present example embodiment, it is assumed that the monitoring image input unit 37 receives the monitoring images imaged by the monitoring camera 80 present at an exit gate, but may receive monitoring images of other monitoring cameras 80.

The correspondence relationship determination unit 38 is a portion that, when a face image of the same person as a subject person imaged in the second monitoring images (monitoring images imaged by the second monitoring camera) is stored in the correspondence information storage unit 12, determines whether the subject person is alone.

When the face image of the same person as the subject person is stored in the correspondence information storage unit 12, it is highly possible that the subject person and a person related to the subject person may leave together. Therefore, when the face image of the same person as the subject person is stored in the correspondence information storage unit 12 and the subject person is leaving alone, it is considered to be highly possibly an abnormal state such as a lost child leaving. Hence, when the face image of the same person as the subject person is stored in the correspondence information storage unit 12, the correspondence information storage unit 12 of the present example embodiment determines whether the subject person is alone.

First, the correspondence relationship determination unit 38 confirms whether the face image of the same person as the subject person is stored in the correspondence information storage unit 12, and determines whether the subject person is alone when the face image of the same person as the subject person is stored in the correspondence information storage unit 12. For example, when a condition formed by combining one or more of the following conditions is satisfied (for example, when all of the following three conditions are satisfied), the correspondence relationship determination unit 38 determines that the subject person is leaving the facility alone from the exit gate.
There is no person holding hands with the subject person.
There is no person with whom the subject person speaks.
There is no other person within a predetermined distance from the subject person.

The notification unit 39 is a portion that issues a notice when the subject person is determined to be alone. For example, the notification unit 39 outputs the notice to the monitoring terminal 50. When the monitoring terminal 50 receives this notice, the facility staff takes measures such as talking to the subject person who is trying to leave the facility, thus making it possible to prevent a child from going out of the facility alone.

In the case of determining that the subject person is alone, the correspondence relationship determination unit 38 may input the face image of the subject person to the face image input unit 11. In such a way, the correspondence image acquisition unit 13 acquires a face image of a person (for example, a guardian of the child) who is related to the subject person at the exit gate from the correspondence information storage unit 12, and the position information output unit 16 outputs a location of the person to the display units of the monitoring terminal 50 and the monitoring device 30. Thus, it becomes possible for the facility staff to look for and talk to the guardian of the child who was trying to leave the facility alone.

An attribute such as adult/child is imparted to each of the face images when the correspondence information storage unit 12 is caused to store the correspondence relationship, thus also making it possible not to issue a notice regarding an adult leaving the facility alone and for a group composed of only adults.

The monitoring device 30 is configured as described above, whereby, when the face image of the same person as the subject person imaged in the second monitoring image is stored in the correspondence information storage unit 12, the monitoring device 30 determines whether the subject person is alone. Then, the monitoring device 30 outputs the notice in the case of determining that the subject person is alone. Thus, a lost child or the like can be prevented from leaving the facility alone, and a time required for the guardian of the lost child to find the lost child can be shortened. Therefore, it becomes possible to increase the possibility that the time required to search for a visitor can be shortened even if the visitor does not hold a specific instrument.

As a method for monitoring a person leaving a facility, in the method described in PTL 2, collation of a face image of a monitoring target is performed, and a notice is issued when the monitoring target is trying to go out from the facility. However, since this method is premised on the fact that the monitoring target does not leave the facility in a normal state, this method cannot be applied to the case in which there are many persons who leave the facility normally.

In contrast, the monitoring device 30 of the present example embodiment issues a notice when the person who has visited the facility together with someone is leaving the facility alone. Thus, it becomes possible to suppress a possibility that an alarm is erroneously given even if the person normally leaves the facility.

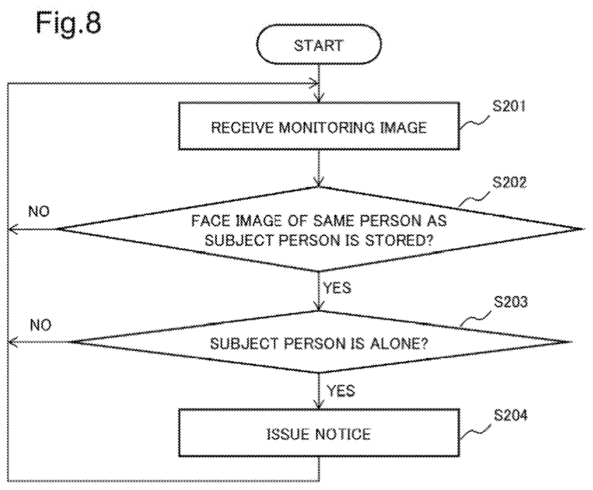

Next, an operation example of the monitoring device 30 of the present example embodiment is illustrated in FIG. 8.

First, when the visitors enter the facility, the staff images a photograph of the visitors, here, a photograph in which the guardian appears together with the child by using the correspondence information registration terminal 70. Then, the correspondence information registration terminal 70 registers the photograph in the correspondence information storage device 60. Thus, the face image of the guardian, the face image of the child, and the fact that these correspond to each other are registered in the correspondence information storage unit 12.

The monitoring device 30 sequentially receives the monitoring images (second monitoring images) from the predetermined monitoring camera 80 (step S201). Next, the monitoring device 30 confirms whether the face image of the same person as the subject person imaged in such a second monitoring image is stored in the correspondence information storage unit 12. Next, when the face image of the same person as the subject person is stored in the correspondence information storage unit 12 (YES in step S202), the monitoring device 30 determines whether the subject person is alone. Then, in the case of determining that the subject person is alone (YES in step S203), the monitoring device 30 issues a notice to the monitoring terminal 50 and the like (step S204).

In the case of determining that the subject person is alone, the monitoring device 30 inputs the face image of the subject person as the key image to the face image input unit 11, thus making it possible to output the location of the person, who is related to the subject person, to the monitoring terminal 50 and the like. An operation example at such case is similar to that of the third example embodiment (FIG. 4), and accordingly, a description thereof is omitted.

The monitoring device 30 may acquire the face image related to the face image of the same person as the subject person in step S202, and in the case of determining that the subject person is alone, may input the acquired face image as the correspondence image to the monitoring image specifying unit 15. In such a way, the monitoring device 30 can output the location of the person, who is related to the subject person, to the monitoring terminal 50 and the like.

By operating as described above, when the face image of the same person as the subject person imaged in the second monitoring image is stored in the correspondence information storage unit 12, the monitoring device 30 determines whether the subject person is alone. Then, the monitoring device 30 outputs the notice in the case of determining that the subject person is alone. Thus, a lost child or the like can be prevented from leaving the facility alone, and the time required for the guardian of the lost child to find the lost child can be shortened. Therefore, it becomes possible to increase the possibility that the time required to search for a visitor can be shortened even if the visitor does not hold a specific instrument.

As described above, in the fourth example embodiment of the present invention, when the face image of the same person as the subject person imaged in the second monitoring image is stored in the correspondence information storage unit 12, the monitoring device 30 determines whether the subject person is alone. Then, the monitoring device 30 outputs a notice in the case of determining that the subject person is alone. Thus, a lost child or the like can be prevented from leaving the facility alone, and the time required for the guardian of the lost child to find the lost child can be shortened. Therefore, it becomes possible to increase the possibility that the time required to search for a visitor can be shortened even if the visitor does not hold a specific instrument.

### Fifth Example Embodiment

Next, a fifth example embodiment of the present invention is described. The present example embodiment is an embodiment which notifies a facility staff when a person whose face image is stored in a correspondence information storage unit 12 is leaving the facility together with a person whom the person has no correspondence relationship with.

A configuration example of a monitoring device 30 of the present example embodiment is similar to that in FIG. 7. Further, a monitoring image input unit 37 is similar to that of the fourth example embodiment.

In the present example embodiment, in the case of determining that the subject person is not alone, a correspondence relationship determination unit 38 further determines whether a person present together with the subject person is a person with the face image related to the face image of the same person as the subject person. Then, a notification unit 39 notifies a monitoring terminal 50 and the like that the person present together with the subject person is different from the person with the face image related to the face image of the same person as the subject person.

It is possible to associate two or more persons with the face image stored by the correspondence information storage unit 12. However, when the correspondence relationship of the person who is leaving the facility is determined as in the present example embodiment, it is desirable to set, to one, the number of children to be associated with one guardian. In such a way, it becomes possible for the monitoring device 30 to also notify the monitoring terminal 50 that children are going to leave the facility by themselves, and for the facility staff to protect the children.

Further, when the subject person has left together with a person in a correct correspondence relationship therewith, the monitoring device 30 may record “already left” on the face image of the subject person, which is stored in the correspondence information storage unit 12. In addition, when all of such persons in the correspondence relationship have left the facility, face images of these persons may be deleted from the correspondence information storage unit 12.

The monitoring device 30 is configured as described above, whereby, when the face image of the same person as the subject person imaged in the second monitoring image is stored in the correspondence information storage unit 12, the monitoring device 30 determines whether the subject person is alone. Further, when the subject person is not alone, the monitoring device 30 further determines whether the person present together with the subject person is the person with the face image related to the face image of the same person as the subject person. Then, the monitoring device 30 issues a notice when the person present together with the subject person is different from the person with the face image related to the face image of the same person as the subject person. Thus, the lost child can be prevented from leaving with a person other than the guardian thereof, and the time required for the guardian of the lost child to find the lost child can be shortened. Therefore, it becomes possible to increase the possibility that the time required to search for a visitor can be shortened even if the visitor does not hold a specific instrument.

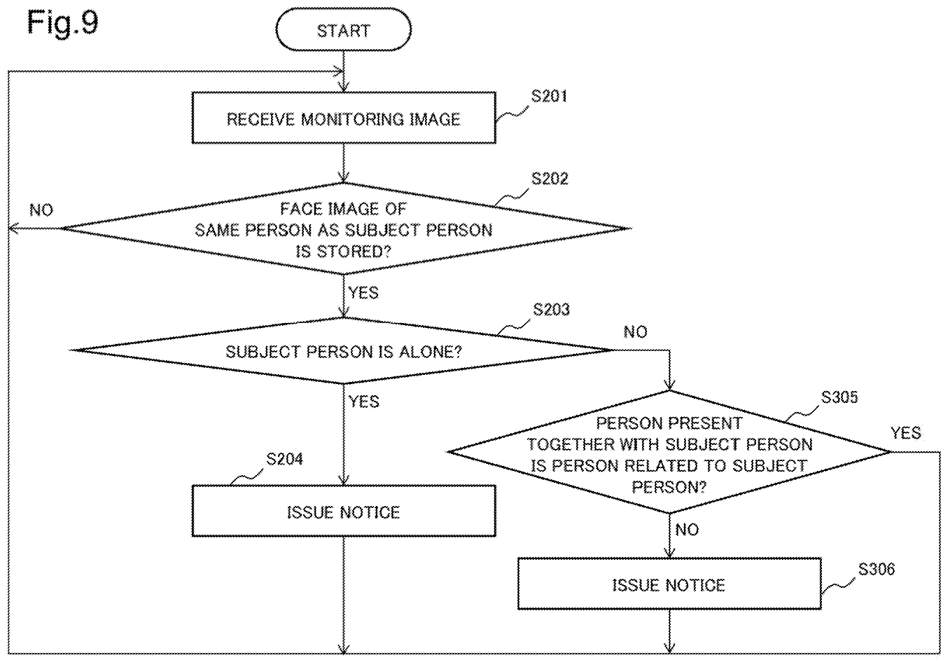

Next, an operation example of the monitoring device 30 of the present example embodiment is illustrated in FIG. 9.

Steps S201 and S202 are similar to those of the fourth example embodiment, and accordingly, a description thereof is omitted.

In the case of determining that the subject person is not alone in step S203 (NO in step S203), the correspondence relationship determination unit 38 further determines whether the person present together with the subject person is the person with the face image related to the face image of the same person as the subject person. Then, the notification unit 39 notifies the monitoring terminal 50 and the like (step S306) when the person present together with the subject person is different from the person with the face image related to the face image of the same person as the subject person (NO in step S305).

By operating as described above, when the face image of the same person as the subject person imaged in the second monitoring image is stored in the correspondence information storage unit 12, the monitoring device 30 determines whether the subject person is alone. When the subject person is not alone, the monitoring device 30 further determines whether the person present together with the subject person is the person with the face image related to the face image of the same person as the subject person. Then, the monitoring device 30 issues a notice when the person present together with the subject person is different from the person with the face image related to the face image of the same person as the subject person. Thus, the lost child can be prevented from leaving with a person other than the guardian thereof, and the time required for the guardian of the lost child to find the lost child can be shortened. Therefore, it becomes possible to increase the possibility that the time required to search for a visitor can be shortened even if the visitor does not hold a specific instrument.

As described above in the fifth example embodiment of the present invention, when the face image of the same person as the subject person imaged in the second monitoring image is stored in the correspondence information storage unit 12, the monitoring device 30 determines whether the subject person is alone. Further, when the subject person is not alone, the monitoring device 30 further determines whether the person present together with the subject person is the person with the face image related to the face image of the same person as the subject person. Then, the monitoring device 30 issues a notice when the person present together with the subject person is different from the person with the face image related to the face image of the same person as the subject person. Therefore, it becomes possible to increase the possibility that the time required to search for a visitor can be shortened even if the visitor does not hold a specific instrument.

### Sixth Example Embodiment

Next, a sixth example embodiment of the present invention is described. The present example embodiment is an example in which such a function to monitor the leaving is made independent of the monitoring device 30 (FIG. 7) of the fourth or fifth example embodiment.

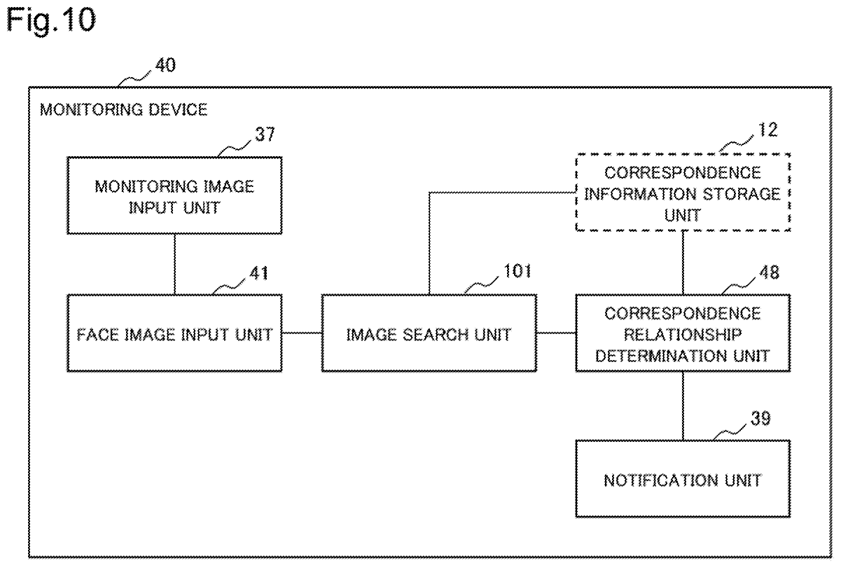

First, a configuration example of a monitoring device 40 of the present example embodiment is illustrated in FIG. 10. The monitoring device 40 of the present example embodiment is composed of a monitoring image input unit 37, a face image input unit 41, an image search unit 101, a correspondence information storage unit 12, a correspondence relationship determination unit 48 and a notification unit 39.

The face image input unit 41 is a portion that receives an input of a key image that is a face image of a person taken as a key.

The monitoring image input unit 37 is a portion that sequentially receives monitoring images from a predetermined monitoring camera, and inputs a face image of a subject person, which is imaged in the monitoring image, as a key image to the face image input unit 41.

The correspondence information storage unit 12 is a portion that stores face images of a plurality of persons and correspondence relationships between the face images.

The image search unit 101 is a portion that searches whether a face image of the same person as the key image (face image of the subject person in the case of the present example embodiment) is stored in the correspondence information storage unit 12.

The correspondence relationship determination unit 48 is a portion that, when the face image of the same person as the subject person is stored in the correspondence information storage unit 12, determines whether the subject person is alone. In addition, in the case of determining that the subject person is not alone, the correspondence relationship determination unit 48 may determine whether a person present together with the subject person is the person with the face image related to the face image of the same person as the subject person.

The notification unit 39 is a portion that issues a notice when the subject person is determined to be alone. The notification unit 39 may further issue a notice when the person present together with the subject person is different from the person with the face image related to the face image of the same person as the subject person.

The monitoring device 40 is configured as described above, whereby, when the face image of the same person as the subject person imaged in the monitoring image is stored in the correspondence information storage unit 12, the monitoring device 40 determines whether the subject person is alone. Then, the monitoring device 40 outputs a notice in the case of determining that the subject person is alone. Thus, the lost child or the like can be prevented from leaving the facility alone, and the time required for the guardian of the lost child to find the lost child can be shortened. Therefore, it becomes possible to increase the possibility that the time required to search for a visitor can be shortened even if the visitor does not hold a specific instrument.

An operation example of the monitoring device 40 of the present example embodiment is similar to the operation example (FIG. 8 or FIG. 9) of such a leaving monitoring function of the monitoring device 30 of the fourth or fifth example embodiment, and accordingly, a description thereof is omitted.

As described above in the sixth example embodiment of the present invention, when the face image of the same person as the subject person imaged in the monitoring image is stored in the correspondence information storage unit 12, the monitoring device 40 determines whether the subject person is alone. Then, the monitoring device 40 outputs the notice in the case of determining that the subject person is alone. Thus, the lost child or the like can be prevented from leaving the facility alone, and the time required for the guardian of the lost child to find the lost child can be shortened. Therefore, it becomes possible to increase the possibility that the time required to search for a visitor can be shortened even if the visitor does not hold a specific instrument.

### [Hardware Configuration Example]

A description is made of a configuration example of a hardware resource that achieves the monitoring device (10, 20, 30, 40, 100) in each of the above-described example embodiments of the present invention by using one information processing device (computer). The monitoring device may be achieved by using at least two information processing devices physically or functionally. Further, the monitoring device may be achieved as a dedicated device. In addition, only a part of a function of the monitoring device may be achieved by using the information processing device.

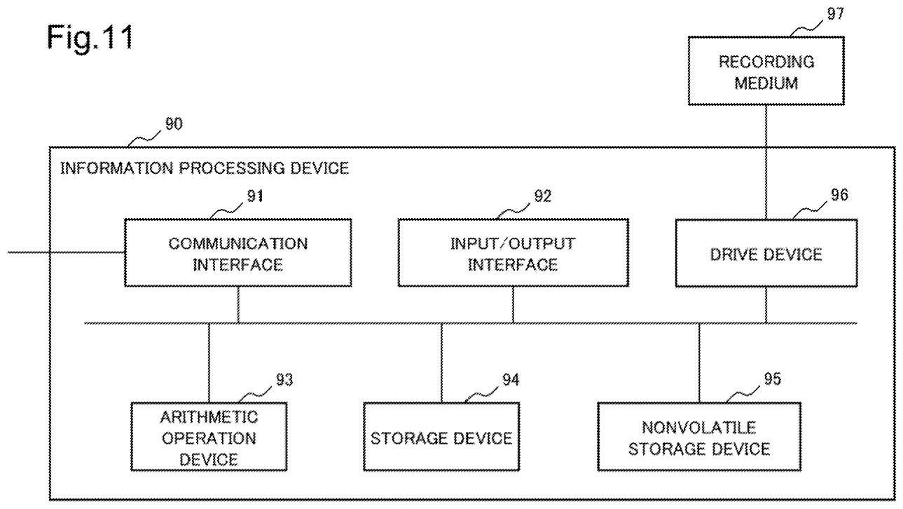

FIG. 11 is a diagram schematically illustrating a hardware configuration example of the information processing device capable of achieving the monitoring device of each of the example embodiments of the present invention. An information processing device 90 includes a communication interface 91, an input/output interface 92, an arithmetic operation device 93, a storage device 94, a nonvolatile storage device 95, and a drive device 96.

The communication interface 91 is a communication means for causing the monitoring device of each of the example embodiments to communicate with an external device in a wired and/or wireless manner. When the monitoring device is achieved by using at least two information processing devices, these devices may be connected to each other in such a way as to be communicable with each other via the communication interface 91.

The input/output interface 92 is a man-machine interface such as a keyboard as one example of an input device and a display as an output device.

The arithmetic operation device 93 is an arithmetic processing device such as general-purpose central processing unit (CPU) and microprocessor. The arithmetic operation device 93 is capable of reading out, for example, a variety of programs, which are stored in the nonvolatile storage device 95, into the storage device 94, and executing processing in accordance with the program thus read out.

The storage device 94 is a memory device such as a random access memory (RAM) capable of being referred to from the arithmetic operation device 93, and stores the program, a variety of data, and the like. The storage device 94 may be a volatile memory device.

The nonvolatile storage device 95 is, for example, a nonvolatile storage device such as a read only memory (ROM) and a flash memory, and is capable of storing varieties of programs, data, and the like.

The drive device 96 is, for example, a device that processes data reading and writing with a recording medium 97 to be described later.

The recording medium 97 is, for example, any recording medium capable of recording data, such as an optical disk, a magneto-optical disk, and a semiconductor flash memory.

For example, each of the example embodiments of the present invention may be achieved in such a way that the monitoring device is configured of the information processing device 90 illustrated in FIG. 11, and that such monitoring device is supplied with a program capable of achieving a function described in each of the above-described example embodiments.

In this case, the arithmetic operation device 93 executes the program supplied to the monitoring device, thus making it possible to achieve the example embodiments. Moreover, it is also possible to configure not all of the monitoring device but a partial function thereof by the information processing device 90.

Moreover, such a configuration may be adopted, in which the above-described program is recorded in the recording medium 97 in advance, and in which the above-described program is stored in the nonvolatile storage device 95 in a shipping stage, an operating stage or the like of the monitoring device. As a supply method of the above-described program in this case, there may be adopted a method of installing the program in the monitoring device by using an appropriate jig in a manufacturing stage before shipment, the operating stage or the like. Moreover, the supply method of the above-described program may adopt a general procedure such as a method of downloading the program from the outside through a communication line such as the Internet.

The whole or part of the example embodiments disclosed above can be described as, but not limited to, the following supplementary notes.

### (Supplementary Note 1)

A monitoring device comprising:

face image input means for receiving an input of a key image being a face image of a person taken as a key; and

image search means for searching whether the face image of a same person as the key image is stored in a correspondence information storage unit that stores the face images of a plurality of persons and correspondence relationships among the face images, and outputting a result of the search.

### (Supplementary Note 2)

The monitoring device according to supplementary note 1, further comprising:

correspondence image acquisition means for acquiring, as a correspondence image, the face image related to the face image of a same person as the key image from the correspondence information storage unit when the face image of the same person as the key image is stored in the correspondence image storage unit;

monitoring image specifying means for specifying a monitoring image, in which a person of the correspondence image is captured, from among monitoring images in a monitoring image storage unit that stores the monitoring images captured by a monitoring camera; and

position information output means for outputting position information of the monitoring camera that captures the specified monitoring image.

### (Supplementary Note 3)

The monitoring device according to supplementary note 2, wherein

the position information output means outputs any one or more of information on a capturing time of the specified monitoring image, the specified monitoring image, and the correspondence image together with the position information.

### (Supplementary Note 4)

The monitoring device according to supplementary note 2 or 3, further comprising:

monitoring image input means for sequentially receiving a second monitoring image from a predetermined second monitoring camera;

correspondence relationship determination means for determining, when the face image of a same person as a subject person captured in the second monitoring image is stored in the correspondence information storage unit, whether the subject person is alone; and notification means for issuing a notice when the subject person is determined to be alone.

### (Supplementary Note 5)

The monitoring device according to supplementary note 4, wherein

the correspondence relationship determination means determines that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 6)

The monitoring device according to supplementary note 4 or 5, wherein

the face image input means receives the face image of the subject person as the key image when the subject person is determined to be alone.

### (Supplementary Note 7)

The monitoring device according to any one of supplementary notes 4 to 6, wherein,

at a time of determining that the subject person is not alone, the correspondence relationship determination means further determines whether a person present together with the subject person is a person with the face image related to the face image of a same person as the subject person, and

the notification means issues the notice when a person present together with the subject person is different from a person with the face image related to the face image of a same person as the subject person.

### (Supplementary Note 8)

The monitoring device according to supplementary note 7, wherein the face image input means receives the face image of the subject person as the key image when a person present together with the subject person is determined to be different from a person with the face image related to the face image of a same person as the subject person.

### (Supplementary Note 9)

The monitoring device according to supplementary note 1, further comprising:

monitoring image input means for sequentially receiving a monitoring image from a predetermined monitoring camera, and inputting the face image of a subject person as the key image to the face image input means, the face image being captured in the monitoring image;

correspondence relationship determination means for determining whether the subject person is alone when the face image of a same person as the subject person is stored in the correspondence information storage unit; and

notification means for issuing a notice when the subject person is determined to be alone.

### (Supplementary Note 10)

The monitoring device according to supplementary note 9, wherein

the correspondence relationship determination means determines that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 11)

The monitoring device according to supplementary note 9 or 10, wherein

at a time of determining that the subject person is not alone, the correspondence relationship determination means further determines whether a person present together with the subject person is a person with the face image related to the face image of a same person as the subject person, and

the notification means issues the notice when a person present together with the subject person is different from a person with the face image related to the face image of the same person as the subject person.

### (Supplementary Note 12)

A monitoring system comprising:

the monitoring device according to any one of supplementary notes 2 to 11; and

the monitoring camera.

### (Supplementary Note 13)

A monitoring method comprising:

receiving an input of a key image being a face image of a person taken as a key; and

searching whether the face image of a same person as the key image is stored in a correspondence information storage unit that stores the face images of a plurality of persons and correspondence relationships among the face images, and outputting a result of the search.

### (Supplementary Note 14)

The monitoring method according to supplementary note 13 further comprising:

acquiring, as a correspondence image, the face image related to the face image of a same person as the key image from the correspondence information storage unit when the face image of the same person as the key image is stored in the correspondence information storage unit;

specifying the monitoring image, in which a person of the correspondence image is captured, from among monitoring images in a monitoring image storage unit that stores monitoring images captured by a monitoring camera; and

outputting position information of the monitoring camera that captures the specified monitoring image.

### (Supplementary Note 15)

The monitoring method according to supplementary note 14, further comprising

outputting any one or more of information on a capturing time of the specified monitoring image, the specified monitoring image, and the correspondence image, together with the position information.

### (Supplementary Note 16)

The monitoring device according to supplementary note 14 or 15, further comprising:

sequentially receiving a second monitoring image from a predetermined second monitoring camera;

determining, when the face image of a same person as a subject person captured in the second monitoring image is stored in the correspondence information storage unit, whether the subject person is alone; and

issuing a notice when the subject person is determined to be alone.

### (Supplementary Note 17)

The monitoring method according to supplementary note 16, further comprising

determining that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 18)

The monitoring method according to supplementary note 16 or 17, further comprising

receiving the face image of the subject person as the key image when the subject person is determined to be alone.

### (Supplementary Note 19)

The monitoring method according to any one of supplementary notes 16 to 18, further comprising:

determining, at a time of determining that the subject person is not alone, whether a person present together with the subject person is a person with the face image related to the face image of a same person as the subject person; and

issuing the notice when a person present together with the subject person is different from a person with the face image related to the face image of a same person as the subject person.

### (Supplementary Note 20)

The monitoring method according to supplementary note 19, further comprising

receiving the face image of the subject person as the key image when a person present together with the subject person is determined to be different from a person with the face image related to the face image of a same person as the subject person.

### (Supplementary Note 21)

The monitoring method according to supplementary note 13, further comprising:

sequentially receiving a monitoring image from a predetermined monitoring camera, and defining the face image of a subject person as the key image, the face image being captured in the monitoring image;

determining, when the face image of a same person as the subject person is stored in the correspondence information storage unit, whether the subject person is alone; and issuing a notice when the subject person is determined to be alone.

### (Supplementary Note 22)

The monitoring method according to supplementary note 21, further comprising

determining that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 23)

The monitoring method according to supplementary note 21 or 22, further comprising:

determining, at a time of determining that the subject person is not alone, whether a person present together with the subject person is a person with the face image related to the face image of a same person as the subject person; and

issuing the notice when a person present together with the subject person is different from a person with the face image related to the face image of the same person as the subject person.

### (Supplementary Note 24)

A computer-readable recording medium recording a monitoring program causing a computer to execute:

a face image input function of receiving an input of a key image being a face image of a person taken as a key; and

an image search function of searching whether the face image of a same person as the key image is stored in a correspondence information storage unit that stores the face images of a plurality of persons and correspondence relationships among the face images, and outputting a result of the search.

### (Supplementary Note 25)

The computer-readable recording medium recording the monitoring program according to supplementary note 24, causing a computer to further execute:

a correspondence image acquisition function of acquiring, as a correspondence image, the face image related to the face image of a same person as the key image from the correspondence information storage unit when the face image of the same person as the key image is stored in the correspondence information storage unit;

a monitoring image specifying function of specifying a monitoring image, in which a person of the correspondence image is captured, from among monitoring images in a monitoring image storage unit that stores the monitoring images captured by a monitoring camera; and

a position information output function of outputting position information of the monitoring camera that captures the specified monitoring image.

### (Supplementary Note 26)

The computer-readable recording medium recording the monitoring program according to supplementary note 25, wherein

the position information output function outputs any one or more of information on a capturing time of the specified monitoring image, the specified monitoring image, and the correspondence image, together with the position information.

### (Supplementary Note 27)

The computer-readable recording medium recording the monitoring program according to supplementary note 25 or 26, causing a computer to further execute:

a monitoring image input function of sequentially receiving a second monitoring image from a predetermined second monitoring camera;

a correspondence relationship determination function of determining, when the face image of a same person as a subject person captured in the second monitoring image is stored in the correspondence information storage unit, whether the subject person is alone; and a notification function of issuing a notice when the subject person is determined to be alone.

### (Supplementary Note 28)

The computer-readable recording medium recording the monitoring program according to supplementary note 27, wherein

the correspondence relationship determination function determines that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 29)

The computer-readable recording medium recording the monitoring program according to supplementary note 27 or 28, wherein

the face image input function receives the face image of the subject person as the key image when the subject person is determined to be alone.

### (Supplementary Note 30)

The computer-readable recording medium recording the monitoring program according to any one of supplementary notes 27 to 29, wherein,

at a time of determining that the subject person is not alone, the correspondence relationship determination function further determines whether a person present together with the subject person is a person with the face image related to the face image of a same person as the subject person, and

the notification function issues the notice when a person present together with the subject person is different from a person with the face image related to the face image of a same person as the subject person.

### (Supplementary Note 31)

The computer-readable recording medium recording the monitoring program according to supplementary note 30, wherein

the face image input function receives the face image of the subject person as the key image when a person present together with the subject person is determined to be different from a person with the face image related to the face image of a same person as the subject person.

### (Supplementary Note 32)

The computer-readable recording medium recording the monitoring program according to supplementary note 24, causing a computer to further execute:

a monitoring image input function of sequentially receiving a monitoring image from a predetermined monitoring camera, and defining the face image of a subject person as the key image, the face image being captured in the monitoring images;

a correspondence relationship determination function of determining whether the subject person is alone when the face image of a same person as the subject person is stored in the correspondence information storage unit; and

a notification function of issuing a notice when the subject person is determined to be alone.

### (Supplementary Note 33)

The computer-readable recording medium recording the monitoring program according to supplementary note 32, wherein the correspondence relationship determination function determines that the subject person is alone when satisfying a condition formed by combining one or more of a condition in which there is no other person within a predetermined distance from the subject person, a condition in which there is no person holding hands with the subject person, and a condition in which there is no person talking with the subject person.

### (Supplementary Note 34)

The computer-readable recording medium recording the monitoring program according to supplementary note 32 or 33, wherein

at a time of determining that the subject person is not alone, the correspondence relationship determination function further determines whether a person present together with the subject person is a person with the face image related to the face image of a same person as the subject person, and

the notification function issues the notice when a person present together with the subject person is different from a person with the face image related to the face image of a same person as the subject person.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-212863, filed on Nov. 2, 2017, the disclosure of which is incorporated herein in its entirety by reference.

### REFERENCE SIGNS LIST

10, 20, 30, 40, 100 Monitoring device
101 Image search unit
11, 41 Face image input unit
12 Correspondence information storage unit
13 Correspondence image acquisition unit
14 Monitoring image storage unit
15 Monitoring image specifying unit
16 Position information output unit
37 Monitoring image input unit
38, 48 Correspondence relationship determination unit
39 Notification unit
50 Monitoring terminal
60 Correspondence information storage device
70 Correspondence information registration terminal
80 Monitoring camera
90 Information processing device
91 Communication interface
92 Input/output interface
93 Arithmetic operation device
94 Storage device
95 Nonvolatile storage device
96 Drive device
97 Recording medium

1. A monitoring device comprising one or more memories storing instructions and one or more processors configured to execute the instructions to:
receive an input of a key image being a face image of a person taken as a key; and
search whether the face image of a same person as the key image is stored in a correspondence information storage unit that stores the face images of a plurality of persons and correspondence relationships among the face images, and output a result of the search.

2. The monitoring device according to claim 1, wherein
the one or more processors configured to execute the instructions to
acquire, as a correspondence image, the face image related to the face image of a same person as the key image from the correspondence information storage unit when the face image of the same person as the key image is stored in the correspondence image storage unit;
specify a monitoring image, in which a person of the correspondence image is captured, from among monitoring images in a monitoring image storage unit that stores the monitoring images captured by a monitoring camera; and
output position information of the monitoring camera that captures the specified monitoring image.

3. The monitoring device according to claim 2, wherein
the one or more processors configured to execute the instructions to output any one or more of information on a capturing time of the specified monitoring image, the specified monitoring image, and the correspondence image together with the position information.

4. The monitoring device according to claim 2, wherein
the one or more processors configured to execute the instructions to
sequentially receive a second monitoring image from a predetermined second monitoring camera;
determine, when the face image of a same person as a subject person captured in the second monitoring image is stored in the correspondence information storage unit, whether the subject person is alone; and
issue a notice when the subject person is determined to be alone.

5. The monitoring device according to claim 4, wherein
the one or more processors configured to execute the instructions to determine that the subject person is alone when satisfying a condition formed by combining one or more of a condition in which there is no other person within a predetermined distance from the subject person, a condition in which there is no person holding hands with the subject person, and a condition in which there is no person talking with the subject person.

6. The monitoring device according to claim 4, wherein
the one or more processors configured to execute the instructions to receive the face image of the subject person as the key image when the subject person is determined to be alone.

7. The monitoring device according to claim 4, wherein,
at a time of determining that the subject person is not alone, the one or more processors configured to execute the instructions to determine whether a person present together with the subject person is a person with the face image related to the face image of a same person as the subject person, and
the one or more processors configured to execute the instructions to issue the notice when a person present together with the subject person is different from a person with the face image related to the face image of a same person as the subject person.

8. The monitoring device according to claim 7, wherein
the one or more processors configured to execute the instructions to receive the face image of the subject person as the key image when a person present together with the subject person is determined to be different from a person with the face image related to the face image of a same person as the subject person.

9. The monitoring device according to claim 1, wherein
the one or more processors configured to execute the instructions to sequentially receive a monitoring image from a predetermined monitoring camera, and input the face image of a subject person as the key image to the face image input means, the face image being captured in the monitoring image;
determine whether the subject person is alone when the face image of a same person as the subject person is stored in the correspondence information storage unit; and
issue a notice when the subject person is determined to be alone.

10. The monitoring device according to claim 9, wherein
the one or more processors configured to execute the instructions to determine that the subject person is alone when satisfying a condition formed by combining one or more of a condition in which there is no other person within a predetermined distance from the subject person, a condition in which there is no person holding hands with the subject person, and a condition in which there is no person talking with the subject person.

11. The monitoring device according to claim 9, wherein,
at a time of determining that the subject person is not alone, the one or more processors configured to execute the instructions to determine whether a person present together with the subject person is a person with the face image related to the face image of a same person as the subject person, and
the one or more processors configured to execute the instructions to issue the notice when a person present together with the subject person is different from a person with the face image related to the face image of the same person as the subject person.

12. A monitoring system comprising:
the monitoring device according to claim 2; and
the monitoring camera.

13. A monitoring method comprising:
receiving an input of a key image being a face image of a person taken as a key; and
searching whether the face image of a same person as the key image is stored in a correspondence information storage unit that stores the face images of a plurality of persons and correspondence relationships among the face images, and outputting a result of the search.

14. The monitoring method according to claim 13, further comprising:
acquiring, as a correspondence image, the face image related to the face image of a same person as the key image from the correspondence information storage unit when the face image of the same person as the key image is stored in the correspondence information storage unit;
specifying the monitoring image, in which a person of the correspondence image is captured, from among monitoring images in a monitoring image storage unit that stores monitoring images captured by a monitoring camera; and
outputting position information of the monitoring camera that captures the specified monitoring image.

15. The monitoring method according to claim 14, further comprising
outputting any one or more of information on a capturing time of the specified monitoring image, the specified monitoring image, and the correspondence image, together with the position information.

16. The monitoring method according to claim 14, further comprising:
sequentially receiving a second monitoring image from a predetermined second monitoring camera;
determining, when the face image of a same person as a subject person captured in the second monitoring image is stored in the correspondence information storage unit, whether the subject person is alone; and
issuing a notice when the subject person is determined to be alone.

17. The monitoring method according to claim 16, further comprising
determining that the subject person is alone when satisfying a condition formed by combining one or more of a condition in which there is no other person within a predetermined distance from the subject person, a condition in which there is no person holding hands with the subject person, and a condition in which there is no person talking with the subject person.

18. The monitoring method according to claim 16, further comprising
receiving the face image of the subject person as the key image when the subject person is determined to be alone.

19. The monitoring method according to claim 16, further comprising:
determining, at a time of determining that the subject person is not alone, whether a person present together with the subject person is a person with the face image related to the face image of a same person as the subject person; and
issuing the notice when a person present together with the subject person is different from a person with the face image related to the face image of a same person as the subject person.

20. (canceled)

21. (canceled)

22. (canceled)

23. (canceled)

24. A non-transitory computer-readable recording medium recording a monitoring program causing a computer to execute:
a face image input function of receiving an input of a key image being a face image of a person taken as a key; and
an image search function of searching whether the face image of a same person as the key image is stored in a correspondence information storage unit that stores the face images of a plurality of persons and correspondence relationships among the face images, and outputting a result of the search.

25. (canceled)

26. (canceled)

27. (canceled)

28. (canceled)

29. (canceled)

30. (canceled)

31. (canceled)

32. (canceled)

33. (canceled)

34. (canceled)
